(19) United States
(12) Patent Application Publication
(10) Pub. No.: US 2025/0150143 A1
(43) Pub. Date: May 8, 2025

(54) MODEM CHIP FOR DETERMINING PRECODING MATRIX BASED ON UNIVERSAL NEURAL NETWORK MODEL AND METHOD OF OPERATING THE MODEM CHIP

(71) Applicant: SAMSUNG ELECTRONICS CO., LTD., Suwon-si (KR)

(72) Inventors: Jaein KIM, Suwon-si (KR); Junho LEE, Suwon-si (KR); Yoojin CHOI, Suwon-si (KR)

(73) Assignee: SAMSUNG ELECTRONICS CO., LTD., Suwon-si (KR)

(21) Appl. No.: 18/936,203

(22) Filed: Nov. 4, 2024

(30) Foreign Application Priority Data
Nov. 6, 2023 (KR) 10-2023-0151950
Apr. 4, 2024 (KR) 10-2024-0046215

(51) Int. Cl. H04B 7/06; H04B 7/0456; H04L 41/16

(52) U.S. Cl. CPC H04B 7/0626; H04B 7/0456; H04L 41/16

(57) ABSTRACT

A method of operating a modem chip in a wireless communication device configured to perform multiple-input and multiple-output (MIMO)-based communication with an external device, includes: receiving channel state information for a channel between the wireless communication device and the external device; generating a channel matrix corresponding to the channel based on the channel state information; generating an input matrix of a preset first size based on a size of a fixed input of a universal neural network model, and the channel matrix; generating an output matrix of a preset second size based on the input matrix and the universal neural network model; and determining a precoding matrix based on the output matrix. The size of the fixed input of the universal neural network model is based on a maximum value of at least one of parameters adjustable in the MIMO-based communication.

### CROSS-REFERENCE TO RELATED APPLICATIONS

This application is based on and claims priority under 35 U.S.C. § 119 to Korean Patent Application Nos. 10-2023-0151950, filed on Nov. 6, 2023, and 10-2024-0046215, filed on Apr. 4, 2024, in the Korean Intellectual Property Office, the disclosures of which are incorporated by reference herein in their entireties.

### BACKGROUND

### 1. Field

The disclosure relates to a modem chip and a method of operating the modem chip, and more specifically, to a modem chip and a method of operating the modem chip that determines a precoding matrix corresponding to each of a plurality of pieces of channel state information (CSI) based on a single neural network model.

### 2. Description of Related Art

Wireless communication systems may employ various techniques to increase throughput. For example, a wireless communication system may employ multiple-input and multiple-output (MIMO) that increases communication capacity using multiple antennas. As techniques for increasing throughput are employed, a transmitting side may transmit a signal having high complexity, while a receiving side may be required to process a signal having high complexity.

The new radio (NR) specification includes a codebook-based transmission mode and a non-codebook-based transmission mode in relation to uplink multi-antenna precoding. In the case of the codebook-based transmission mode, a precoding matrix available to a terminal is specified by a standard. In the case of the non-codebook-based transmission mode, the terminal may autonomously calculate the precoding matrix. In order to improve channel capacity and data transmission rate, it is required for the terminal to adaptively determine an appropriate precoding matrix according to channel state information.

### SUMMARY

Provided are a modem chip and a method of operating the modem chip that reduces model storage capacity and model switching overhead by determining a precoding matrix corresponding to each of a plurality of pieces of channel state information (CSI), based on a single neural network model.

The technical aspects of the disclosure are not limited to the technical tasks described above, and other technical tasks not mentioned may be understood by a person skilled in the art from the following description.

According to an aspect of the disclosure, a modem chip in a wireless communication device configured to perform multiple-input and multiple-output (MIMO)-based communication with an external device, the modem chip includes: a radio frequency integrated circuit (RFIC) configured to receive a received signal including channel state information; and at least one processor configured to determine a precoding matrix used to transmit data to the external device based on the channel state information, and to output transmission data based on the precoding matrix, wherein the at least one processor is further configured to: generate a channel matrix corresponding to a channel between the external device and the wireless communication device based on the channel state information, generate an input matrix of a preset first size by performing a pre-processing operation on the channel matrix based on the channel matrix and the channel state information, generate an output matrix corresponding to the input matrix based on a universal neural network model, an input size of the universal neural network model being equal to the preset first size, determine the precoding matrix by performing a post-processing operation corresponding to a reverse operation of the pre-processing operation on the output matrix of a preset second size corresponding to an output size of the universal neural network model.

According to an aspect of the disclosure, a method of operating a modem chip in a wireless communication device configured to perform multiple-input and multiple-output (MIMO)-based communication with an external device, includes: receiving channel state information for a channel between the wireless communication device and the external device; generating a channel matrix corresponding to the channel based on the channel state information; generating an input matrix of a preset first size based on a size of a fixed input of a universal neural network model, and the channel matrix; generating an output matrix of a preset second size based on the input matrix and the universal neural network model; and determining a precoding matrix based on the output matrix. The size of the fixed input of the universal neural network model is based on a maximum value of at least one of parameters adjustable in the MIMO-based communication.

According to an aspect of the disclosure, a modem chip in a wireless communication device configured to perform multiple-input and multiple-output (MIMO)-based communication with an external device, includes: a radio frequency integrated circuit (RFIC) configured to receive a received signal including channel state information; and at least one processor configured to determine a precoding matrix used to transmit data to the external device based on the channel state information, wherein the at least one processor is further configured to: generate a channel matrix corresponding to a channel based on the channel state information, generate a diagonal matrix including singular values and right singular vectors, by performing singular value decomposition on the channel matrix, generate an input matrix including valid components of the diagonal matrix including the singular values and having a preset first size, generate an output matrix corresponding to the input matrix based on a universal neural network model, an input size of the universal neural network model being equal to the preset first size, and determine the precoding matrix based on the output matrix and the right singular vectors.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment;

FIG. 2 illustrates a wireless communication device according to an embodiment;

FIG. 3 illustrates an example of a neural network for describing a universal neural network model according to an embodiment;

FIG. 4 illustrates a universal neural network module, according to an embodiment;

FIG. 5 illustrates zero padding according to an embodiment;

FIG. 6 illustrates operations of a universal neural network module, according to an embodiment;

FIG. 7 illustrates a method of determining a precoding matrix, according to an embodiment;

FIG. 8 illustrates a method of operating a modem chip, according to an embodiment;

FIG. 9 illustrates a method of operating a modem chip, according to an embodiment;

FIG. 10 illustrates a method of operating a modem chip, according to an embodiment; and

FIG. 11 illustrates a wireless communication device according to an embodiment.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under circumstances.

Before undertaking the detailed description below, it may be advantageous to set forth definitions of certain words and phrases used throughout the disclosure. The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

In the disclosure, a wireless communication device is an entity that communicates with a base station or another wireless communication device, and is referred to as a node, a user equipment (UE), a next generation UE (NG UE), a mobile station (MS), a mobile equipment (ME), a device, or a terminal.

In addition, wireless communication devices may include at least one of a smartphone, tablet personal computer (tablet PC), mobile phone, video phone, e-book reader, desktop PC, laptop PC, netbook computer, portable digital assistant (PDA), portable multimedia player (PMP), MP3 player, medical device, camera, or wearable device. In addition, wireless communication devices may include at least one of televisions, digital video disk (DVD) players, audio, refrigerators, air conditioners, vacuum cleaners, ovens, microwaves, washing machines, air purifiers, set-top boxes, home automation control panels, security control panels, media boxes (e.g., Samsung HomeSync™, Apple TV™, or Google TV™), game consoles (e.g., Xbox™, PlayStation™), electronic dictionaries, electronic keys, camcorders, or electronic frames. In addition, wireless communication devices may include at least one of various medical devices (e.g., various portable medical measurement devices (such as blood glucose meter, heart rate meter, blood pressure meter, or body temperature meter), magnetic resonance angiography (MRA), magnetic resonance imaging (MRI), computed tomography (CT), photographer, ultrasound, or the like), navigation devices, global navigation satellite system (GNSS), event data recorder (EDR), flight data recorder (FDR), automobile infotainment devices, ship electronic equipment (e.g., ship navigation devices, gyro compass, etc.), avionics, security devices, vehicle head units, industrial or household robots, drones, ATMs of financial institutions, point of sales of stores, or Internet of Things devices (e.g., light bulbs, various sensors, sprinklers, fire alarms, temperature regulators, street lamps, toasters, exercise equipment, hot water tanks, heaters, boilers, etc.). In addition, wireless communication devices may include various types of multimedia systems capable of performing communication functions.

A base station is an entity that communicates with a wireless communication device and allocates communication network resources to the wireless communication device, and may be at least one of a cell, a base station (BS), a NodeB (NB), an eNodB (eNB), a gNodeB (gNB), a next generation radio access network (NG RAN), a radio access unit, a base station controller, or a node on a network. A transmitter may refer to a node that provides data services or voice services. The node may be fixed or may be moved. A receiver may refer to a node that receives a data service or a voice service. For example, in the case of uplink, a wireless communication device may be a transmitter and a base station may be a receiver. In the case of downlink, a wireless communication device may be a receiver, and a base station may be a transmitter.

In embodiments of the disclosure described below, a hardware approach will be described as an example. However, since the embodiments of the disclosure include technology that uses both hardware and software, the embodiments of the disclosure do not exclude a software-based approach.

Hereinafter, embodiments of the disclosure will be described in detail with reference to the accompanying drawings.

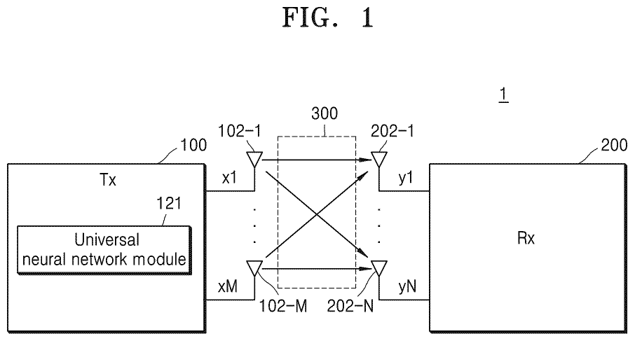

FIG. 1 illustrates a communication system according to an embodiment. Referring to FIG. 1, a communication system 1 may include a transmitter 100 and a receiver 200 for wireless communication through a multiple-input and multiple-output (MIMO) channel 300.

The system 1 may be any system including the MIMO channel 300. In some embodiments, the system 1 may be a wireless communication system such as a 5th generation (5G) wireless system, a Long Term Evolution (LTE) system, wireless fidelity (WiFi) system, or the like, as a non-limiting example. In some embodiments, the system 1 may be a wired communication system such as a storage system, a network system, or the like. Hereinafter, the system 1 will be mainly described as a wireless communication system, but embodiments of the disclosure are not limited thereto.

For example, the transmitter 100 and the receiver 200 may be any one of a wireless communication device or a base station. A wireless communication network between the transmitter 100 and the receiver 200 may support multiple users to communicate with each other by sharing available network resources. For example, in wireless communication networks, information may be transmitted to receivers or from transmitters in a variety of ways, such as code division multiple access (CDMA), Frequency Division Multiple Access (FDMA), Time Division Multiple Access (TDMA), Orthogonal Frequency Division Multiple Access (OFDMA), and Single Carrier Frequency Division Multiple Access (SC-FDMA).

Referring to FIG. 1, the transmitter 100 may determine a multi-antenna transmission method using ‘channel state information’ (CSI). The transmitter 100 may obtain channel state information from the receiver 200. The channel state information is information on the MIMO channel 300 and may vary when the environment of the MIMO channel 300 changes. For example, a base station may transmit a ‘channel state information-reference signal’ (CSI-RS) to a wireless communication device. The wireless communication device may perform downlink channel estimation based on the received CSI-RS. Furthermore, the wireless communication device may transmit a channel state information feedback to the base station. The base station may obtain downlink channel state information by receiving the channel state information feedback from the wireless communication device. As another example, a wireless communication device may estimate an uplink channel using the received CSI-RS based on channel reciprocity.

In addition, as another specific example, the wireless communication device may transmit a ‘sounding reference signal’ (SRS) to the base station. The base station may acquire uplink channel state information based on the received SRS. In addition, the base station may acquire downlink channel state information using the received SRS based on channel reciprocity. The wireless communication device may acquire channel state information through various reference signals, synchronization signal blocks (SSBs), feedback, and the like, and is not limited to the above-described embodiments. Hereinafter, the system 1 may be described on the premise that the wireless communication device is the transmitter 100.

The wireless communication device according to an embodiment, that is, the transmitter 100 of FIG. 1 may determine a precoding matrix using channel state information, and may determine a beamforming vector based on the determined precoding matrix. Accordingly, the transmitter 100 may transmit data to the receiver 200 based on the determined beamforming vector. The transmitter 100 according to an embodiment may determine a precoding matrix corresponding to each of a plurality of pieces of channel state information that may vary according to the environment of the MIMO channel 300 based on a single neural network model. Hereinafter, the above-described ‘single neural network model’ may be referred to as a ‘universal neural network model.’

Referring to FIG. 1, the transmitter 100 includes a plurality of transmission antennas 102-1 to 102-M (hereinafter, M is a positive integer) and may transmit a plurality of symbols x1 to xM to the receiver through the plurality of transmission antennas 102-1 to 102-M, respectively. In addition, the receiver 200 has a plurality of reception antennas 202-1 to 202-N (hereinafter, N is a positive integer) and may receive a plurality of symbols y1 to yN from the transmitter through the plurality of reception antennas 202-1 to 202-N, respectively.

For example, when the symbol vector transmitted from the transmitter 100 is expressed as x=[x1, . . . , xM], the symbol vector y=[y1, . . . , yN] received by the receiver 200 may be expressed by Equation 1 below.

$$y = HFx + n \qquad [ Equation 1 ]$$

In Equation 1, H is a channel matrix, F is a precoding matrix, and n is a noise vector. The size of the reception symbol y is Nᵣ×1. Nᵣ refers to the number of reception antennas used for receiving symbol vectors. Referring to FIG. 1, Nᵣ is N. The size of the channel matrix H is Nᵣ×Nₜ. Nₜ refers to the number of transmission antennas used for transmitting symbol vectors. Referring to FIG. 1, Nₜ is M. The size of the precoding matrix F is Nₜ×Nₛ. Nₛ refers to the number of layers used for transmitting and receiving symbol vectors. That is, Nₛ refers to the number of data streams. However, this is an example, and as described below, Nₜ may be M or less and Nᵣ may be N or less depending on the environment of the MIMO channel 300.

Each of Nᵣ, Nₜ, and Nₛ may vary depending on the environment of the MIMO channel 300. Specifically, Nᵣ, Nₜ, and Nₛ may each vary in the range according to Equation 2 below depending on the environment of the MIMO channel 300.

$$\begin{matrix}1 \leq {N}_{t} \leq {N}_{t}^{max} \\ 1 \leq {N}_{r} \leq {N}_{r}^{max} \\ 1 \leq {N}_{s} \leq {N}_{s}^{max}\end{matrix} \qquad [ Equation 2 ]$$

In Equation 2, Nₜ^{max} is the total number of antennas included in the transmitter 100, Nᵣ^{max} is the total number of antennas included in the receiver 200, and Nₛ^{max} is the maximum number of layers that may be used for transmission and reception of symbol vectors. For example, referring to FIG. 1, Nₜ^{max} may be M, and Nᵣ^{max} may be N.

The transmission symbol xj (j is 1 to M) may be one of signal constellation points. A constellation point may correspond to a point on a complex plane used by the transmitter 100 to map a transmission signal. The number and positions of constellation points on the complex plane may differ according to a modulation method of the transmission signal. For example, when the transmitter 100 modulates a transmission signal using a Quadrature Phase Shift Keying (QPSK) method, one constellation point may be located in each quadrant of the complex plane. That is, four constellation points may be used for modulation of a transmission signal. The transmitter 100 that modulates the transmission signal using a QPSK method may map the transmission signal to one of the four constellation points and transmit the transmission signal to the receiver 200. However, the modulation method of the transmitter 100 is not limited thereto, and, In some embodiments, the transmission signal may be modulated using 16QAM, 64QAM, 256QAM, and 1024QAM methods.

The transmitter 100 according to an embodiment may include a universal neural network module 121. The transmitter 100 may determine an optimal precoding matrix corresponding to each of the plurality of pieces of channel state information based on the universal neural network model included in the universal neural network module 121. For example, the transmitter 100 may estimate, from the channel state information, modulation order information (e.g., a value indicating whether the modulation scheme refers to which of Quadrature Phase Shift Keying (QPSK), 16Quadrature Amplitude Modulation (QAM), 64QAM, 256QAM, and 1024QAM) which is used for transmitting and receiving symbol vectors, rank information (e.g., a value indicating the number of layers used), channel matrix, noise information, and the like. In an embodiment, the above-described modulation order information, rank information, and the like are collectively referred to as estimation results. As described above, since the channel state information may vary according to the environment of the MIMO channel 300, the estimation result may adaptively vary according to the channel state information. The transmitter 100 according to an embodiment may determine an optimal precoding matrix corresponding to the estimation result based on a single neural network model (i.e., a universal neural network model of an embodiment) even when the estimation result is changed by a change in the environment of the MIMO channel 300. The optimal precoding matrix may be selected based on a precoding matrix and a codebook generated based on the output of the universal neural network model of an embodiment. However, the disclosure is not limited thereto, and the transmitter 100 according to an embodiment may generate a precoding matrix based on the universal neural network model of an embodiment in a transmission mode that is not based on the codebook and transmit a signal.

Compared to the case of determining an optimal precoding matrix based on a neural network model corresponding to each of a plurality of pieces of channel state information, since the transmitter 100 according to an embodiment uses a single neural network model (referring to a universal neural network of an embodiment), neural network model storage capacity and switching overhead may be reduced.

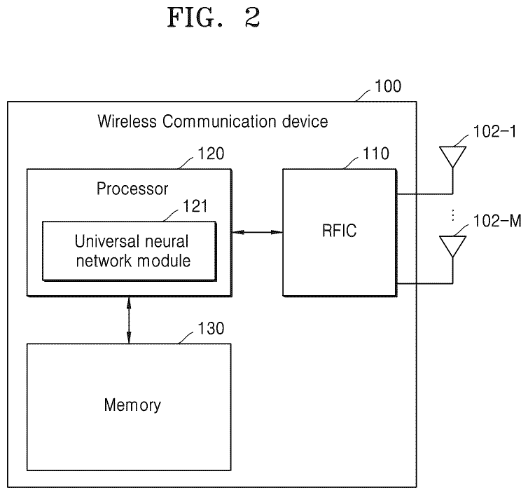

FIG. 2 illustrates a wireless communication device according to an embodiment;

A wireless communication device 100 of FIG. 2 may correspond to the transmitter 100 of FIG. 1 described with reference to FIG. 1, and redundant descriptions are omitted.

Referring to FIG. 2, the wireless communication device 100 according to an embodiment may include a radio frequency integrated circuit (RFIC) 110, a processor 120 (at least one processor 120), a memory 130 (at least one memory 130), and a plurality of antennas 102-1 to 102-M. The wireless communication device 100 may further include various components in addition to the components shown in FIG. 2. The RFIC and the processor may be included in a single modem chip.

The wireless communication device 100 may access a wireless communication system by transmitting and receiving signals (which may be referred to as data in an embodiment) through at least one of a plurality of antennas 102-1 to 102-M.

The RFIC 110 may transmit and receive a symbol vector (referred to as ‘data’ in some embodiments of the disclosure) through at least one of the plurality of antennas 102-1 to 102-M. That is, at least some of the plurality of antennas 102-1 to 102-M may correspond to transmission antennas. The transmission antenna may transmit a signal to an external device (e.g., another wireless communication device or base station (BS)) rather than the wireless communication device 100. At least some of the remaining antennas 102-1 to 102-M may correspond to reception antennas. The reception antenna may receive a wireless signal from the external device.

For example, the RFIC 110 may receive a received signal including channel state information about a channel between the wireless communication device 100 and the base station through the plurality of antennas 102-1 to 102-M. Referring to what was described above with reference to FIG. 1, the RFIC 110 can receive a CSI-RS from the base station.

The processor 120 may control the overall operation of the wireless communication device 100, and as an example, the processor 120 may be a central processing unit (CPU). The processor 120 may include a single core or a multi-core. The processor 120 may process or execute programs and/or data stored in the memory 130. In an embodiment, the processor 120 may control various functions of the wireless communication device 100 or perform various operations by executing programs stored in the memory 130. In some embodiments, the processor 120 may correspond to one or more processors (at least one processor) that may include or correspond to circuitry like a CPU, a microprocessor unit (MPU), an application processor (AP), a coprocessor (CP), a system-on-chip (SoC), or an integrated circuit (IC).

The processor 120 may calculate a channel matrix based on channel state information included in a received signal received by the RFIC 110. The processor 120 may estimate rank information corresponding to the number of layers used for data transmission and reception, modulation order information corresponding to the method of modulating the transmitted and received data, and noise of a channel, based on the channel state information included in the received signal received by the RFIC. In an embodiment, the channel state information may include the above-described rank information, modulation order information, noise, and the like.

According to an embodiment, the processor 120 may determine a precoding matrix that corresponds to the channel state information and maximizes an effective channel capacity, based on the channel matrix and the channel state information. The processor 120 may output data based on the precoding matrix. The wireless communication device 100 may transmit the data based on the precoding matrix.

The processor 120 may include a universal neural network module 121. The universal neural network module 121 may include a processing circuit such as hardware including a logic circuit and a combination of hardware/software such as a processor executing software, or a combination thereof. For example, more specifically, the processing circuit may include an Artistic Logic Unit (ALU), a digital signal processor, a microcomputer, a field programmable gate array (FPGA), a microprocessor, an application-specific integrated circuit (ASIC), and the like, but the disclosure is not limited to the above examples.

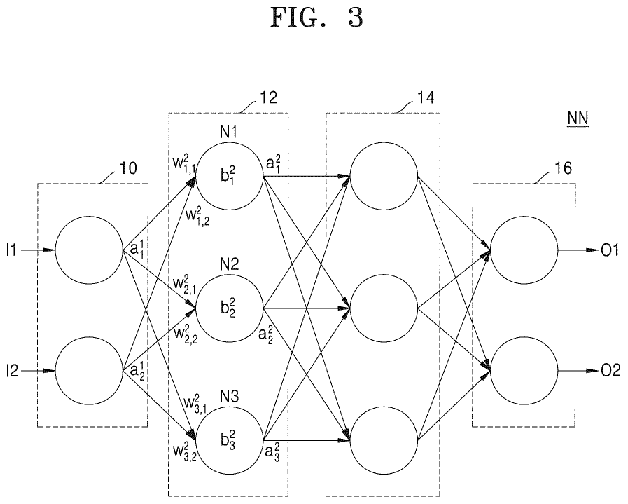

The universal neural network module 121 according to an embodiment may determine a precoding matrix corresponding to channel state information based on a universal neural network model based on a neural network. More specifically, the universal neural network module 121 may determine a precoding matrix corresponding to each of a plurality of pieces of channel state information based on a single neural network model (i.e., a universal neural network model). A detailed description of the structure of the universal neural network model will be described later with reference to FIG. 3.

FIG. 3 illustrates an example of a neural network for describing a universal neural network model according to an embodiment.

The universal neural network model according to an embodiment may be based on a neural network. As described above, the universal neural network module (e.g., 121 in FIG. 2) according to an embodiment may include a universal neural network model to be described later.

The neural network NN of FIG. 3 is a non-limiting example of the universal neural network model structure. Referring to FIG. 3, a neural network NN may have a structure including an input layer, hidden layers, and an output layer. The neural network NN may perform an operation based on received input data (e.g., I1 and I2), and generate output data (e.g., O1 and O2) based on a performance result.

In some embodiments, the neural network NN may be a deep neural network DNN or n-layers neural networks including two or more hidden layers. For example, the neural network NN may be a DNN including an input layer 10, first and second hidden layers 12 and 14, and an output layer 16. In addition, the neural network NN may be any one of a convolution neural network (CNN), a multi-layer perceptron (MLP), and a transformer. The plurality of layers may be implemented as a convolutional layer, a fully-connected layer, a softmax layer, or the like. For example, the convolution layer may include convolution, pooling, effective function operations, and the like. Alternatively, each of the convolution, pooling, and activity function operations may constitute a layer. However, as described above, the SR neural network model according to an embodiment is not limited thereto.

The outputs of the plurality of layers 10, 12, 14, and 16 may be referred to as ‘features’ (or feature maps). The plurality of layers 10, 12, 14, and 16 may generate output features or output signals by receiving features generated from a previous layer as input features and calculating the input features. Features refer to data that expresses various characteristics of input data that a neural network (NN) may recognize.

When the neural network NN has a DNN structure, the neural network NN may include more layers capable of extracting valid information, so that the neural network NN may process complex data sets. In some embodiments, the neural network NN may include four layers 10, 12, 14, and 16. In some other embodiments, the neural network NN may include fewer or more layers. In addition, the neural network NN may include layers having various structures different from those shown in FIG. 3.

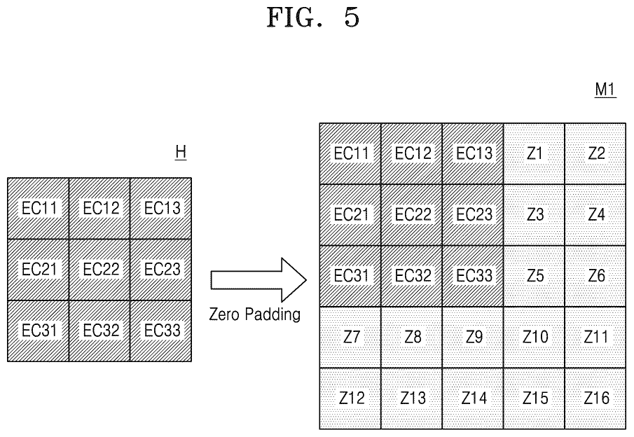

Each of the plurality of layers 10, 12, 14, and 16 included in the neural network NN may include a plurality of neurons. Neurons may correspond to multiple artificial nodes known as processing elements (PE), units, or similar terms. For example, as shown in FIG. 5, the input layer 10 may include two neurons (nodes), and each of the first and second hidden layers 12 and 14 may include three neurons (nodes). However, this is only an example, and each of the layers included in the neural network NN may include various numbers of neurons (nodes).

Neurons in each of the plurality of layers 10, 12, 14, and 16 (in the neural network NN) may be connected to each other to exchange data. One neuron may receive data from other neurons and perform a calculation, and may output the calculation result to other neurons.

The input and output of each of the neurons (nodes, such as N1, N2 and N3) may be referred to as input activation and output activation. That is, activation may be a parameter corresponding to an output of one neuron and an input of neurons included in the next layer. Each of the neurons may determine its output activation based on output activations (e.g., a₁¹, a₂¹, a₁², a₂², a₃², etc.), weights (e.g., w_{1,1}², w_{1,2}², w_{2,1}², w_{2,2}², w_{3,1}², w_{3,2}², etc.) and biases (e.g., b₁², b₂², b₃², etc.), which are received from neurons included in the previous layer. Weight and bias are parameters (referred to as weighting parameters) used to calculate output activation in each neuron, and each weight is a value assigned to a connection relationship between neurons, and each bias represents a weight related to each neuron.

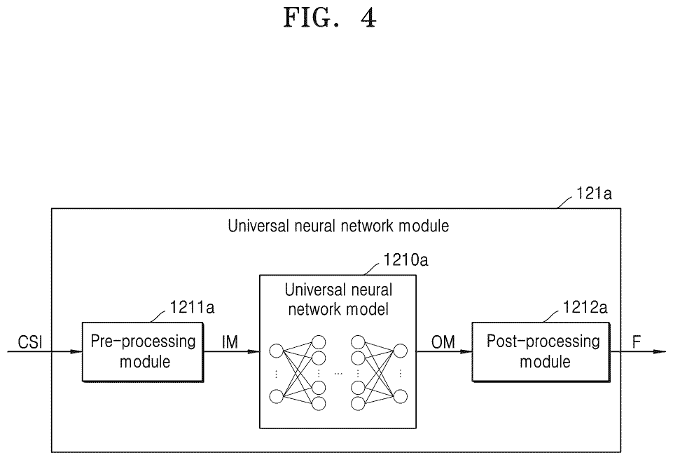

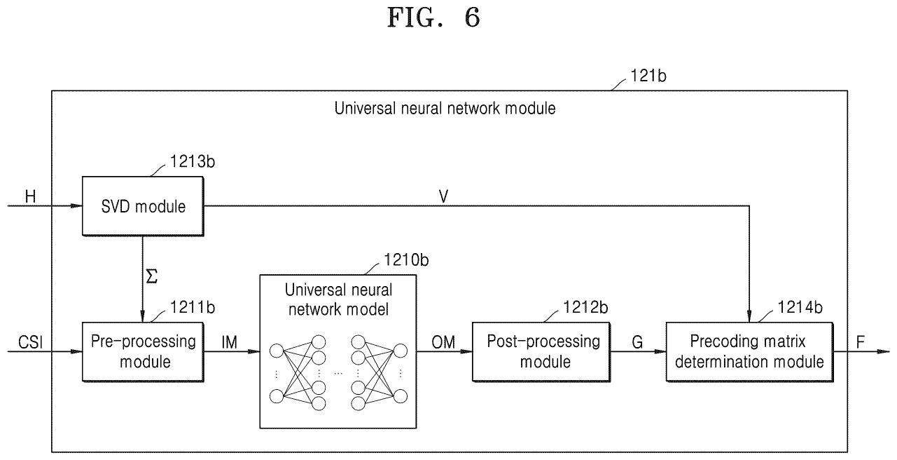

The neural network NN may determine parameters such as weight and bias based on a loss function. The loss function according to an embodiment may be based on mutual information. However, this is only an example, and the loss function according to an embodiment is not limited thereto, and may be determined based on at least one of values related to an effective channel capacity. A more detailed description of the loss function of an embodiment will be described later with reference to FIGS. 4 and 6.

According to an embodiment, the universal neural network model may update the weight and bias so that mutual information according to the determined precoding matrix is maximized. Update of weights and/or biases (i.e., update of parameters) may be referred to as ‘training’ (of fitting) a universal neural network model.

The universal neural network model according to an embodiment may have a constant input size as illustrated in FIG. 3. Therefore, in order to determine a precoding matrix by applying the universal neural network model to the plurality of pieces of channel state information, the size of the input corresponding to each of the plurality of pieces of channel state information may be the same. For example, referring to FIG. 3, since there are two input data (I1 and I2), the size of the input may be 1×2. Similarly, the output of the universal neural network model may have a constant size regardless of the channel state information.

For example, referring to FIG. 3, since there are two output data (O1 and O2), the size of the output may be 1×2. Accordingly, the processor 120 (in FIG. 2) may adjust the size of the input so that the sizes of the input matrices of the universal neural network model based on each of the plurality of pieces of channel state information are the same. For example, pieces of channel state information (e.g., first channel state information and second channel state information) according to a first MIMO channel environment and a second MIMO channel environment may be different. Accordingly, rank information, modulation order information, and the like included in the channel state information may be different, and the size of the channel matrix calculated based on the channel state information may be different. For example, when the number of transmission antennas used in the first MIMO channel environment is Nt1 and the number of reception antennas is Nr1, the calculated size of the first channel matrix may be Nr1×Nt1. When the number of transmission antennas used in the second MIMO channel environment is Nt2 (different from Nt1) and the number of reception antennas is Nr2 (different from Nr1), the calculated size of the second channel matrix may be Nr2×Nt2. Therefore, in order to determine a precoding matrix corresponding to a plurality of pieces of channel state information based on a single neural network model (i.e., a universal neural network model of an embodiment), the processor (120 in FIG. 2) may perform a pre-processing operation to be described later so that the size of an input matrix generated based on the channel matrix and channel state information is the same. In addition, the processor (120 in FIG. 2) according to an embodiment may perform a post-processing operation of adjusting the size of an output matrix corresponding to the output of the universal neural network model to determine the precoding matrix. The post-processing operation may correspond to an operation corresponding to the above-described pre-processing operation, and more detailed description will be given later together with the description of the pre-processing.

In some embodiments, the input of the universal neural network model may be referred to as an input matrix IM in FIG. 4, and the output of the universal neural network model may be referred to as an output matrix OM in FIG. 4. As described above, the processor 120 (in FIG. 2) according to an embodiment may generate an input matrix based on the channel state information. However, embodiments are not limited thereto, and the processor 120 (in FIG. 2) according to an embodiment may include an input matrix that further includes error vector magnitude (EVM) information of a transmission path. The EVM may indicate the degree of distortion between an ideal transmission signal and a generated signal. The EVM information may include at least one of additional white Gaussian noise (AWGN), power amplifier non-linearity, in-phase and quadrant (IQ)mismatch, phase noise, local oscillator leakage (LOL), digital to analog conversion (DAC) quantization noise, and thermal noise.

When the input matrix further includes EVM information, the size of the input matrix may be larger than when the former does not include the latter, and correspondingly, the size of the input of the universal neural network model may be larger. The processor 120 (in FIG. 2) according to an embodiment may generate an output matrix corresponding to the input matrix based on the universal neural network model, and may determine a precoding matrix based on the output matrix.

FIG. 4 illustrates a universal neural network module according to an embodiment. Referring to FIG. 4, a universal neural network module 121a according to an embodiment may include a pre-processing module 1211a, a universal neural network model 1210a, and a post-processing module 1212a. As described above, the universal neural network module 121a may include a processing circuit such as hardware including a logic circuit, a combination of hardware/software such as a processor executing software, or a combination thereof. In FIG. 4, the universal neural network module 121a is shown to include separate components. In some embodiments, each component may be one hardware, or a combination of hardware and software. FIG. 4 may be understood with reference to the above description, and redundant descriptions thereof are omitted.

Referring to FIG. 4, the universal neural network model 1210a may receive an input matrix IM. The universal neural network model 1210a may generate an output matrix OM for determining a precoding matrix based on an input matrix IM. As described above, the sizes of the input and the output of the universal neural network model 1210a may have fixed sizes.

The universal neural network model 1210a according to an embodiment may generate an output matrix OM for determining a precoding matrix having maximum mutual information based on an input matrix IM. The mutual information may be calculated through Equation 3 below. Accordingly, the universal neural network model 1210a according to an embodiment may be trained so that mutual information is maximized based on the channel matrix, rank information, modulation order information, and noise information. That is, Equation 3 is a loss function of the universal neural network model 1210a according to an embodiment, and the universal neural network model 1210a may be trained so that mutual information is maximized.

$$ℒ = - {𝔼}_{x , n} [ {log}_{2} \frac{{e}^{- \frac{1}{{σ}^{2}} {‖ n ‖}^{2}}}{{\sum }_{v ∈ {x}_{M}^{{N}_{s}}} {e}^{- \frac{1}{{σ}^{2}} {‖ H F ( x - v ) + n ‖}^{2}}} ] + η \vert tr ( {( {F}^{un} )}^{H} {F}^{un} ) - P \vert \qquad [ Equation 3 ]$$

In Equation 3, H is the channel matrix, Nₛ is the number of layers, n is the additive noise vector, P is the transmission power, σ² is the reciprocal of Signal to Noise Ratio (SNR), and χ_{M} is the number of constellation points according to the modulation method. In Equation 3, the first term is a term for the above-described mutual information, and the second term is a term for a power constraint. In the second term, tr(F^{UN})^{H}F^{UN}) may be a sum power constraint. The second term may vary according to a power constraint condition. For example, when the power constraint is a per-stream power constraint, the second term may be based on ∥F(:,l)∥=P. Here, l is a value that satisfies 1≤l≤Nₛ.

The pre-processing module 1211a according to an embodiment may receive channel state information CSI. As described above, the channel state information CSI may be determined according to the MIMO channel environment, and may include information used for data transmission and reception. For example, the pre-processing module 1211a may generate a channel matrix based on the channel state information CSI, and estimate rank information corresponding to the number of layers used for data transmission and reception, modulation order information for a method of modulating data, and the like.

The pre-processing module 1211a according to an embodiment may generate an input matrix IM based on the channel state information CSI. As described above, the size of the input matrix IM may be the same as the size of the input of the universal neural network model 1210a. The pre-processing module 1211a may adjust the size of the channel matrix by performing a pre-processing operation on the channel matrix to match the size of the input of the universal neural network model 1210a. Hereinafter, a pre-processing operation for generating the input matrix IM corresponding to the size of the input of the universal neural network model 1210a will be described. The pre-processing operation according to an embodiment may include at least one of the following operations, and is not limited to an order to be described later. The pre-processing operation according to an embodiment collectively refers to a processing operation for generating an input matrix IM having the same size based on different channel state information.

The pre-processing operation may include zero-padding, which will be described below with reference to FIG. 5. For example, when the number of transmission antennas used for data transmission and reception between a wireless communication device and an external device is Nₜ and the number of reception antennas is Nᵣ, the size of the channel matrix may be Nᵣ×Nₜ. The pre-processing module 1211a according to an embodiment may generate a first matrix having a size of Nᵣ^{max}×Nₜ^{max} by performing zero-padding to adjust the size of the channel matrix. Here, Nᵣ^{max} is the total number of antennas included in the receiver, and Nₜ^{max} is the total number of antennas included in the transmitter. The first matrix may include a channel matrix, and the remaining components may be zero. Accordingly, the pre-processing module 1211a according to an embodiment may generate the first matrix having a constant size regardless of the number of transmission antennas (Nₜ) and the number of reception antennas (Nᵣ), which may vary according to channel state information. Accordingly, the universal neural network module 121a according to an embodiment may determine an optimal precoding matrix for each of the plurality of pieces of channel state information. Therefore, the wireless communication device according to an embodiment may reduce the amount of storage capacity and switching overhead for storing a plurality of neural network models for determining an optimal precoding matrix for each of the plurality of pieces of channel state information.

The pre-processing operation according to an embodiment may further include a reshape for the first matrix. The reshape means reshaping components of a matrix. For example, when a plurality of components included in the channel matrix are a complex number, the pre-processing module 1211a may divide each of the plurality of components into a real number part and an imaginary number part and reshape the divided result to generate a second matrix. Therefore, the size of the second matrix in which the first matrix is reshaped may be 1×2Nₜ^{max}Nᵣ^{max}. Unlike the above, the pre-processing module 1211a according to another embodiment may perform zero padding after reshaping the channel matrix. In order to distinguish the reshape included in the pre-processing operation from the reshape included in the post-processing operation to be described later, the reshape included in the pre-processing operation is hereinafter referred to as a first reshape.

As described above, the pre-processing module 1211a according to an embodiment may estimate rank information and modulation order information based on the channel state information CSI. The pre-processing module 1211a may perform one-hot encoding on rank information and modulation order information to generate a third matrix having a predetermined size. For example, the size of the third matrix may be determined based on the total number of possible modulation methods and the maximum number of layers (Nₛ^{max}) that may be used to transmit data.

The pre-processing module 1211a according to an embodiment may generate an input matrix IM by concatenating the noise information estimated based on the channel state information CSI with the second and third matrices. Referring to the above, the size of the input matrix IM may be determined by Nᵣ^{max}, Nₜ^{max}, and Nₛ^{max}, and Nᵣ^{max}, Nₜ^{max}, and Nₛ^{max} may have a constant value regardless of the channel state information CSI, and thus, the size of the input matrix IM may have a predetermined size regardless of the channel state information CSI. The size of the input matrix IM according to the above-described example may be greater than or equal to 1×2Nₜ^{max}Nᵣ^{max}+Nₛ^{max} (i.e., 2Nₜ^{max}Nᵣ^{max}+Nₛ^{max}).

As described above, the pre-processing operation according to an embodiment is not limited to the above-described example. For example, the pre-processing module 1211a may directly use each of the modulation order information and the rank information without performing one-hot encoding on the modulation order information and the rank information. Even in this case, the size of the input matrix IM may be determined by Nᵣ^{max}, Nₜ^{max}, and Nₛ^{max}, and the size of the input matrix IM may have a predetermined size regardless of the channel state information CSI.

The universal neural network model 1210a may generate an output matrix OM. The size of the output matrix OM may be 1×2Nₜ^{max}Nₛ^{max}. The post-processing module 1212a may generate a precoding matrix F corresponding to the channel state information SCI by performing, on the output matrix OM, a post-processing operation corresponding to the pre-processing operation in the pre-processing module 1211a. Referring to an example of the above-described pre-processing operation, the post-processing operation may include a slice operation corresponding to zero-padding and a second reshape corresponding to the first reshape. Specifically, in the post-processing module 1212a, the slice operation may refer to an operation for extracting an valid component included in the output matrix OM, and the second reshape may refer to an inverse operation of the first reshape. Similarly to the pre-processing operation, the order of the slice operation and the second rearrangement may be reversed. That is, the post-processing operation may collectively refer to an operation for generating a precoding matrix F having a size according to the channel state information CSI. Therefore, based on the number Nₜ of transmission antennas and the number Nₛ of layers, which are estimated from channel state information CSI, the size of the precoding matrix F may be a Nₜ×Nₛ.

As described above, the size of each of the input matrix IM and the output matrix OM according to an embodiment may be based on a maximum value of at least one of adjustable parameters in a MIMO. As described above, the size of each of the input and output of the universal neural network model 1210a according to an embodiment may be fixed. The sizes of the input and the size of the output of the universal neural network model 1210a according to an embodiment may be based on a maximum value of at least one of adjustable parameters in the MIMO. Parameters adjustable in the MIMO may include the rank information, modulation order information, noise, and the number of transmission/reception antennas described above. For example, the size of the input matrix IM may be determined based on a maximum value of each of the rank information and the number of transmission antennas from among parameters adjustable in the MIMO. That is, as described above, the size of the input matrix IM may be Nᵣ^{max}×Nₜ^{max}. Accordingly, the size of each of the input and output of the universal neural network model 1210a according to an embodiment may be fixed.

FIG. 5 illustrates zero padding according to an embodiment. FIG. 5 illustrates the zero-padding described above with reference to FIG. 4. Description of FIG. 5 will be given later with reference to the description of FIG. 4.

Referring to FIG. 5, a channel matrix H may be a 3×3 matrix. The size of the matrix according to embodiments may correspond to the form of the matrix or the number of components included in the matrix. For example, the size of the channel matrix H of FIG. 5 may be referred to as 3×3 or 9. The channel matrix H may include nine valid components EC11 to EC33.

As described above, the processor 120 (in FIG. 2) according to an embodiment may calculate a channel matrix based on the channel state information. Referring to FIG. 5, since the size of the channel matrix H is 3×3, the number of transmission antennas of the channel is 3, and the number of reception antennas is 3.

The pre-processing module 1211a (in FIG. 4) according to an embodiment may generate a first matrix M1 by performing zero-padding on the channel matrix H. Referring to FIG. 5, the size of the first matrix M1 is 5×5. The first matrix M1 may include 25 components EC11 to EC33 and Z1 to Z16. The nine components EC11 to EC33 included in the first matrix M1 are the same as the valid components of the channel matrix H, and the 16 components Z1 to Z16 included in the first matrix M1 are components added to the channel matrix H by zero-padding. Values of the 16 components Z1 to Z16 may be zero. In some embodiments, as described above, the valid components EC11 to EC33 of the channel matrix H may have complex number values. The pre-processing module 1211a of FIG. 4 may perform zero-padding to generate the first matrix M1 having a size of Nᵣ^{max}×Nₜ^{max}. Therefore, referring to FIG. 5, the total number (Nᵣ^{max}) of antennas included in the receiver may be 5, and the total number (Nₜ^{max}) of antennas included in the transmitter may be 5. Accordingly, the pre-processing module 1211a of FIG. 4 according to an embodiment may generate the first matrix M1 having a constant size regardless of the number of transmission antennas (Nₜ) and the number of reception antennas (Nᵣ), which may vary according to channel state information. Based on this, the wireless communication device according to an embodiment may determine a precoding matrix corresponding to each of a plurality of pieces of channel state information based on a single neural network model (a universal neural network model of the embodiment).

The first matrix M1 may include the channel matrix H. Referring to FIG. 5, the channel matrix H may be included in an upper-left end of the first matrix M1. Embodiments of the disclosure are not limited thereto. For example, the channel matrix H may be included in a lower-right end of the first matrix M1. The slice operation described above with reference to FIG. 4 may be performed based on the location of the channel matrix H included in the first matrix M1.

As described above with reference to FIG. 4, the pre-processing module 1211a (in FIG. 4) according to an embodiment may rearrange the components EC11 to EC33 and Z1 to Z16 included in the first matrix M1 to generate a second matrix. Referring to FIG. 5, the size of the second matrix may be 1×50 (or 50).

FIG. 6 illustrates operations of a universal neural network module according to an embodiment. FIG. 6 may be understood with reference to the above description, and in particular, may be understood with reference to FIG. 4.

Configuration and operation of the universal neural network module 121b described below with reference to FIG. 6 include some configurations and operations added to the configuration and operation of the universal neural network module 121a described above with reference to FIG. 4. The amount of calculation for determining the precoding matrix may be reduced by the added configurations and operations. Hereinafter, the additional configurations and operations will be described later, and redundant description thereof will be omitted.

Referring to FIG. 6, a universal neural network module 121b according to an embodiment may include a pre-processing module 1211b, a universal neural network model 1210b, a post-processing module 1212b, a singular value decomposition (SVD) module 1213b, and a precoding matrix determination module 1214b.

The processor 120 (in FIG. 2) according to an embodiment may calculate the channel matrix H based on the received channel state information CSI. The SVD module 1213b according to an embodiment may apply a SVD to the channel matrix H. Equation 4 shows the SVD for the channel matrix H.

$$H = U Σ {V}^{H} \qquad [ Equation 4 ]$$

Referring to Equation 4, the SVD module 1213b may decompose the channel matrix H into right singular vectors V, left singular vectors U, and a diagonal matrix including singular values Σ. V^{H} is a Hermitian matrix of right singular vectors V. The diagonal matrix including the singular values may be a rectangular diagonal matrix. Therefore, the diagonal components of the diagonal matrix Σ including the singular values may be referred to as the valid components. The number of diagonal components of the diagonal matrix Σ including singular values may be the number of layers Nₛ used for data transmission and reception.

The pre-processing module 1211b according to an embodiment may receive channel state information CSI and a diagonal matrix Σ including singular values. The pre-processing module 1211b may use the diagonal components of the diagonal matrix Σ including singular values to generate the input matrix IM. The pre-processing module 1211b may generate a fourth matrix having a size of 1×Nₛ^{max} by performing zero-padding on valid components included in the diagonal matrix Σ including singular values. Nₛ^{max} is the maximum number of layers that a wireless communication device may use for data transmission and reception. The pre-processing module 1211b may generate an input matrix IM based on the fourth matrix. In more detail, the pre-processing module 1211a according to an embodiment may generate an input matrix IM by bonding, to the fourth matrix, a matrix corresponding to each of the modulation order information and the noise information. Therefore, the size of the input matrix IM may be greater than or equal to 1×Nₛ^{max}. As described above, the size of the input matrix IM may be determined by Nₛ^{max}, and the size of the input matrix IM may have a predetermined size regardless of the channel state information CSI.

As described above with reference to FIG. 4, the size of the input matrix IM of the universal neural network model 1210a may be greater than or equal to 1×2Nₜ^{max}Nᵣ^{max}+Nₛ^{max} and the size of the input matrix IM of the universal neural network model 1210b of FIG. 6 may be greater than or equal to 1×Nₛ^{max}. Therefore, since the size of the input matrix IM of the universal neural network model 1210b is smaller than the size of the input matrix IM of the universal neural network model 1210a of FIG. 4, the size of the universal neural network model 1210b may be smaller than that of the universal neural network model 1210a of FIG. 4.

The universal neural network model 1210b according to an embodiment may generate an output matrix OM for determining a precoding matrix having maximum mutual information based on an input matrix IM. The mutual information may be calculated through Equation 5 below. Accordingly, the universal neural network model 1210b according to an embodiment may be trained so that mutual information is maximized based on the channel matrix, modulation order information, and noise information. That is, Equation 5 is a loss function of the universal neural network model 1210b according to an embodiment, and the universal neural network model 1210b may be trained so that mutual information is maximized.

$$ℒ = - {𝔼}_{x , n} [ {log}_{2} \frac{{e}^{- \frac{1}{{σ}^{2}} {‖ \overline{n} ‖}^{2}}}{{\sum }_{v ∈ {x}_{M}^{{N}_{s}}} {e}^{- \frac{1}{{σ}^{2}} {‖ Σ ( \text{?} ) G ( x - v ) + Π ‖}^{2}}} ] + η \vert tr ( {( {G}^{un} )}^{H} {G}^{un} ) - P \vert \qquad [ Equation 5 ]$$

$$\text{?} \text{indicates text missing or illegible when filed}$$

Equation 5 may be understood with reference to the above-described Equation 3 and the description of Equation 3.

The universal neural network model 1210b may generate an output matrix OM. The size of the output matrix OM may be 1×2(Nₛ^{max})². As described above, the post-processing module 1212b may perform, on the output matrix OM, a post-processing operation corresponding to the pre-processing operation in the pre-processing module 1211b. The post-processing module 1212b may perform a post-processing operation on the output matrix OM to generate an adjustment matrix G corresponding to the channel state information CSI. The size of the adjustment matrix G may be Nₛ×Nₛ.

The precoding matrix determination module 1214b may determine the precoding matrix F by multiplying the adjustment matrix G by the right singular vectors V. Therefore, based on the number Nₜ of transmission antennas and the number Nₛ of layers, which are estimated from the channel state information CSI, the size of the precoding matrix F may be a Nₜ×Nₛ.

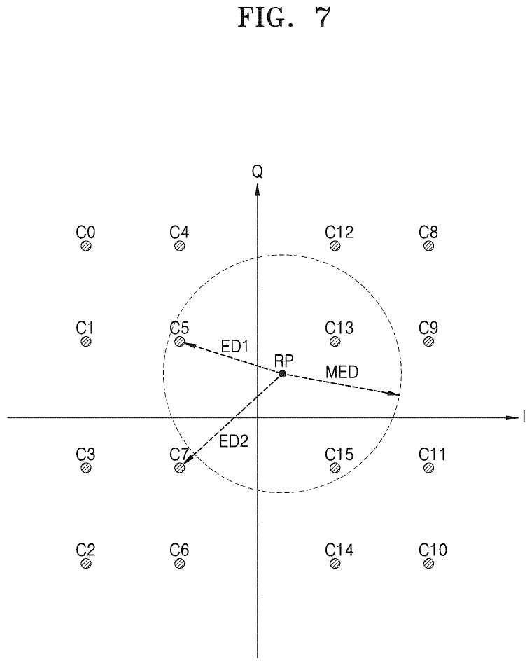

FIG. 7 illustrates a method of determining a precoding matrix according to an embodiment. FIG. 7 may be described with reference to Equations 3 and 5 described above.

FIG. 7 shows a complex plane on which candidate vectors are displayed. A plurality of constellation points C0 to C15 may be displayed on the complex plane. A symbol transmitted through one channel may be expressed as a point RP on a complex plane. FIG. 7 illustrates constellation points C0 to C15 based on 16QAM, but embodiments are not limited thereto, and features to be described below may also be applied to the QPSK, 64QAM, 256QAM, and 1024QAM methods.

As described above, the processor 120 (in FIG. 2) may obtain channel state information from the received signal received by the RFIC 110 (in FIG. 1). The channel state information may include modulation order information and rank information. When the rank and modulation order according to the rank information and the modulation order information are high, the calculations of Equations 3 and 5 described above may be very complicated. That is, |χ_{M}^{N}^{ₛ}| in the first term of Equations 3 and 5 becomes too large, and the complexity of calculation may increase. Accordingly, power and time consumed for the calculation may increase. For example, when the modulation order corresponds to 256QAM and the rank is 3, the calculation for determining the precoding matrix may be complicated because |χ_{M}^{N}^{ₛ}| is 256³.

The processor 120 (in FIG. 2) according to an embodiment may determine the precoding matrix through Equations 3 and 5 based on k constellation points located in the vicinity of the given transmitted symbol vector x (in Equation 1). That is, χ_{M}^{N}^{ₛ} in Equations 3 and 5 is replaced with χ_{M}ⁿ^{ₛ}(x,K) to reduce the complexity of calculations.

The k constellation points located in the vicinity of the symbol vector (i.e., RP of FIG. 7) may be determined based on the Euclidean distance. Referring to FIG. 7, the wireless communication device according to an embodiment may determine the precoding matrix based on constellation points that are closer to the minimum Euclidean distance MED from the point RP. For example, since the sixth constellation point C5 is spaced apart from the point RP by a first Euclidean distance ED1 less than the minimum Euclidean distance MED, the sixth constellation point C5 may be classified as a constellation point in the vicinity of the point RP. In some embodiments, since the eighth constellation point C7 is spaced apart by a second Euclidean distance ED2 greater than the minimum Euclidean distance MED, the eighth constellation point C7 may not be distinguished by the constellation point in the vicinity of the point RP and may not be considered in the calculation to determine the precoding matrix.

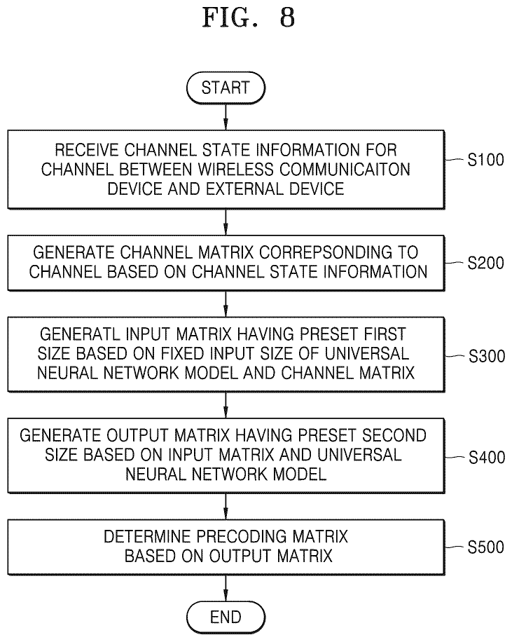

FIG. 8 illustrates a method of operating a modem chip, according to an embodiment. As described above with reference to FIG. 2, the RFIC 110 (in FIG. 2) and the processor 120 (in FIG. 2) may be implemented as a single modem chip.

Referring to FIG. 8, in operation S100, the modem chip may receive channel state information on a channel between a wireless communication device and an external device.

In operation S200, the modem chip may generate a channel matrix corresponding to the channel based on the channel state information.

In operation S300, the modem chip may generate an input matrix having a preset first size based on a fixed input size of the universal neural network model and the channel matrix.

In operation S400, the modem chip may generate an output matrix having a preset second size based on the input matrix and the universal neural network model.

In operation S500, the modem chip may determine a precoding matrix based on the output matrix.

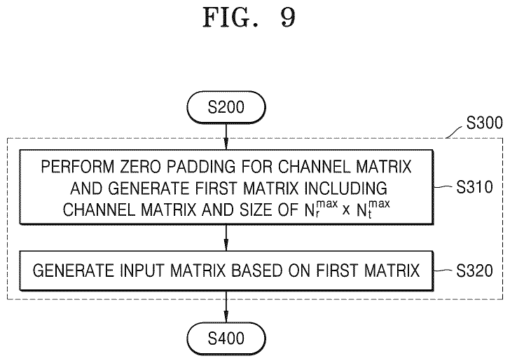

FIG. 9 illustrates a method of operating a modem chip, according to an embodiment. FIG. 9 illustrates operation S300 of FIG. 8 specified according to an embodiment. As described above, the total number of antennas of the external device is Nᵣ^{max}, the total number of antennas of the wireless communication device is Nₜ^{max}, and the maximum number of layers available for data transmission and reception between the external device and the wireless communication device is Nₛ^{max}.

In operation S310, the modem chip may perform zero padding on the channel matrix to generate a first matrix including the channel matrix and having a size of Nᵣ^{max}×Nₜ^{max}.

In operation S320, the modem chip may generate an input matrix based on the first matrix. The first size of the input matrix may be predetermined based on Nₛ^{max}, Nᵣ^{max}, and Nₜ^{max}.

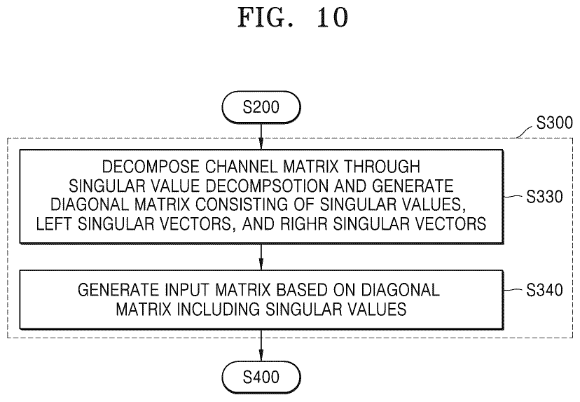

As described above, the size of the output matrix according to an embodiment of FIG. 10 may be 1×2Nₜ^{max}Nₛ^{max}, and the size of the precoding matrix may be smaller than the size of the output matrix.

FIG. 10 illustrates a method of operating a modem chip, according to an embodiment. FIG. 10 illustrates operation S300 of FIG. 8 specified according to an embodiment. As described above, the total number of antennas of the external device is Nᵣ^{max}, the total number of antennas of the wireless communication device is Nₜ^{max}, and the maximum number of layers available for data transmission and reception between the external device and the wireless communication device is Nₛ^{max}.

In operation S330, the modem chip may decompose the channel matrix through SVD, and may generate a diagonal matrix including singular values, left singular vectors, and right singular vectors.

In operation S340, the modem chip may generate an input matrix based on a diagonal matrix including singular values. The input matrix may include valid components included in the diagonal matrix including singular values, and the size of the input matrix may be 1×Nₛ^{max} or more.

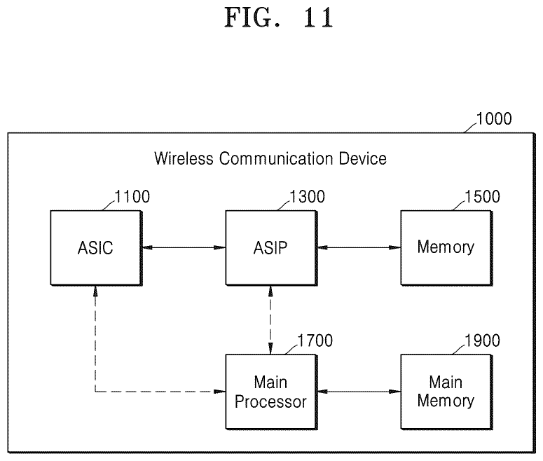

FIG. 11 illustrates a wireless communication device according to an embodiment. The wireless communication device 1000 of FIG. 11 may correspond to the wireless communication device 100 of FIG. 2, and redundant descriptions thereof are omitted.

Referring to FIG. 11, the wireless communication device 1000 may include an application specific integrated circuit (ASIC) 1100, an application specific instruction set processor (ASIP) 1300, a memory 1500, a main processor 1700, and a main memory 1900. At least two of the ASIC 1100, the ASIP 1300, and the main processor 1700 may communicate with each other. In addition, at least two of the ASIC 1100, the ASIP 1300, the memory 1500, the main processor 1700, and the main memory 1900 may be embedded in one chip. For example, as described above, at least two of the ASIC 1100, the ASIP 1300, the memory 1500, the main processor 1700, and the main memory 1900 may be included in a single modem chip.

The ASIP 1300 is an integrated circuit customized for a specific purpose, may support a dedicated instruction set for a specific application, and may execute an instruction included in the instruction set. The memory 1500 may communicate with the ASIP 1300 and may store a plurality of instructions executed by the ASIP 1300 as a non-transitory storage device. For example, the memory 1500 may include any type of memory accessible by the ASIP 1300, such as, for non-limiting example, random access memory (RAM), read only memory (ROM), tape, a magnetic disk, an optical disk, a volatile memory, a non-volatile memory, and a combination thereof.

The main processor 1700 may control the wireless communication device 1000 by executing a plurality of instructions. For example, the main processor 1700 may control the ASIC 1100 and the ASIP 1300, process received data, or process a user's input to the wireless communication device 1000. The main memory 1900 may communicate with the main processor 1700 and store a plurality of instructions executed by the main processor 1700 as a non-transitory storage device. For example, the main memory 1900 may include any type of memory accessible by the main processor 1700, such as, as a non-limiting example, RAM, ROM, tape, a magnetic disk, an optical disk, a volatile memory, a non-volatile memory, and a combination thereof.

The wireless communication device and the method of operating the wireless communication device according to an embodiment described with reference to FIGS. 1 to 11 may be performed by at least one of components included in the wireless communication device 1000 of FIG. 11. In some embodiments, at least one operation of the method of operating the wireless communication device described above may be implemented as a plurality of instructions stored in the memory 1500. In some embodiments, the ASIP 1300 may perform at least one of the operations of the method by executing the plurality of instructions stored in the memory 1500.

While the aspects of the disclosure have been particularly shown and described with reference to embodiments thereof, various changes in form and details may be made therein without departing from the spirit and scope of the following claims.

The embodiments may be described and illustrated in terms of blocks, as shown in the drawings, which carry out a described function or functions. These blocks, which may be referred to herein as the universal neural network module 121, the pre-processing module 1211a, the universal neural network model 1210a, the post-processing module 1212a, the SVD module 1213b, the pre-processing module 1211b, the post-processing module 1212b, the precoding matrix determination module 1214b or the like may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

What is claimed is:

1. A modem chip in a wireless communication device configured to perform multiple-input and multiple-output (MIMO)-based communication with an external device, the modem chip comprising:
a radio frequency integrated circuit (RFIC) configured to receive a received signal including channel state information; and
at least one processor configured to determine a precoding matrix used to transmit data to the external device based on the channel state information, and to output transmission data based on the precoding matrix,
wherein the at least one processor is further configured to:
generate a channel matrix corresponding to a channel between the external device and the wireless communication device based on the channel state information,
generate an input matrix of a preset first size by performing a pre-processing operation on the channel matrix based on the channel matrix and the channel state information,
generate an output matrix corresponding to the input matrix based on a universal neural network model, an input size of the universal neural network model being equal to the preset first size,
determine the precoding matrix by performing a post-processing operation corresponding to a reverse operation of the pre-processing operation on the output matrix of a preset second size corresponding to an output size of the universal neural network model.

2. The modem chip of claim 1, wherein a total number of antennas of the external device is Nᵣ^{max},
wherein the total number of antennas of the wireless communication device is Nₜ^{max}, where Nᵣ^{max} and Nₜ^{max} are integers of 1 or more, and
wherein the pre-processing operation comprises:
performing a zero padding operation to generate a first matrix including the channel matrix and having a size Nᵣ^{max}×Nₜ^{max}, and
generating the input matrix based on the first matrix.

3. The modem chip of claim 1, wherein a total number of antennas of the external device is Nᵣ^{max},
wherein the total number of antennas of the wireless communication device is Nₜ^{max},
wherein a maximum number of layers available for data transmission and reception between the external device and the wireless communication device is Nₛ^{max}, where Nᵣ^{max}, Nₜ^{max}, and Nₛ^{max} are integers of 1 or more, and
wherein the preset first size of the input matrix is 2Nₜ^{max}Nᵣ^{max}+Nₛ^{max} or more.

4. The modem chip of claim 1, wherein a total number of antennas of the wireless communication device is Nₜ^{max},
wherein a maximum number of layers available for data transmission and reception between the external device and the wireless communication device is Nₛ^{max}, where Nₜ^{max} and Nₛ^{max} are integers of 1 or more, and
wherein the preset second size of the output matrix is 1×2Nₜ^{max}Nₛ^{max}.

5. The modem chip of claim 1, wherein the at least one processor is further configured to:
generate a diagonal matrix including singular values, left singular vectors, and right singular vectors, by performing singular value decomposition on the channel matrix;
generate the input matrix based on a singular value decomposition matrix and the channel state information; and
determine the precoding matrix based on the input matrix and the right singular vectors.

6. The modem chip of claim 5, wherein a maximum number of layers available for data transmission and reception between the external device and the wireless communication device is Nₛ^{max}, where Nₛ^{max} is an integer of 1 or more, and
wherein the pre-processing operation comprises:
a zero padding operation to generate a first matrix having a size 1×Nₛ^{max} and
a plurality of efficient components in the diagonal matrix including the singular values, to generate the input matrix based on the first matrix.

7. The modem chip of claim 6, wherein the preset first size of the input matrix is 1×Nₛ^{max} or more.

8. The modem chip of claim 5, wherein a maximum number of layers available for data transmission and reception between the external device and the wireless communication device is Nₛ^{max}, where Nₛ^{max} is an integer of 1 or more, and
wherein the preset second size of the output matrix is 1×2(Nₛ^{max})².

9. The modem chip of claim 5, wherein the channel state information further comprises rank information on a number of layers used for data transmission/reception, and the number of layers according to the rank information is Nₛ,
wherein the at least one processor is further configured to generate the post-processing operation corresponding to the reverse operation of the pre-processing operation on the output matrix to generate an adjustment matrix having a size of Nₛ×Nₛ, and
wherein the precoding matrix is a product of the right singular vectors and the adjustment matrix.

10. The modem chip of claim 1, wherein the channel state information comprises rank information corresponding to the number of layers used for data transmission and reception and modulation order information for the transmitted and received data, and
wherein the at least one processor is further configured to, when a number of data streams based on a combination of the rank information and the modulation order information is greater than or equal to a threshold value, determine the precoding matrix based on at least one constellation point whose distance from a symbol corresponding to the data is less than a minimum Euclidean distance.

11. A method of operating a modem chip in a wireless communication device configured to perform multiple-input and multiple-output (MIMO)-based communication with an external device, the method comprising:
receiving channel state information for a channel between the wireless communication device and the external device;
generating a channel matrix corresponding to the channel based on the channel state information;
generating an input matrix of a preset first size based on a size of a fixed input of a universal neural network model, and the channel matrix;
generating an output matrix of a preset second size based on the input matrix and the universal neural network model; and
determining a precoding matrix based on the output matrix,
wherein the size of the fixed input of the universal neural network model is based on a maximum value of at least one of parameters adjustable in the MIMO-based communication.

12. The method of claim 11, wherein a total number of antennas of the external device is Nᵣ^{max},
wherein the total number of antennas of the wireless communication device is Nₜ^{max},
wherein a maximum number of layers available for data transmission and reception between the external device and the wireless communication device is Nₛ^{max}, where Nᵣ^{max}, Nₜ^{max}, and Nₛ^{max} are integers of 1 or more, and
wherein the preset first size of the input matrix is predetermined based on Nₛ^{max}, Nᵣ^{max}, and Nₜ^{max}.

13. The method of claim 11, wherein the generating of the input matrix comprises:
performing zero padding on the channel matrix to generate a first matrix including the channel matrix and having a size Nᵣ^{max}×Nₜ^{max}; and
generating the input matrix based on the first matrix.

14. The method of claim 11, wherein a total number of antennas of the wireless communication device is Nₜ^{max},
wherein a maximum number of layers available for data transmission and reception between the external device and the wireless communication device is Nₛ^{max}, where Nₛ^{max} and Nₛ^{max} are integers of 1 or more,
wherein the preset second size is 1×2Nₛ^{max}Nₜ^{max}, and
wherein the size of the precoding matrix is smaller than the preset second size.

15. The method of claim 11, wherein a maximum number of layers available for data transmission and reception between the external device and the wireless communication device is Nₛ^{max}, where Nₛ^{max} is an integer of 1 or more,
wherein the generating of the input matrix comprises generating a diagonal matrix including singular values, left singular vectors, and right singular vectors, by performing a singular value decomposition of the channel matrix, and
wherein the input matrix comprises an valid component in the diagonal matrix including a singular value, and the size of the input matrix is 1×Nₛ^{max} or more.

16. The method of claim 15, wherein the maximum number of layers available for data transmission and reception between the external device and the wireless communication device is Nₛ^{max}, where Nₛ^{max} is an integer of 1 or more, and
wherein the preset second size of the output matrix is 1×2(Nₛ^{max})².

17. The method of claim 15, wherein the channel state information further comprises rank information on a number of layers used for data transmission/reception, the number of layers according to the rank information is Nₛ, and
wherein the determining of the precoding matrix comprises:
adjusting the preset second size of the channel matrix to generate an adjustment matrix whose size is Nₛ×Nₛ; and
determining the precoding matrix by obtaining a product of the adjustment matrix and the right singular vectors.

18. The method of claim 12, wherein the channel state information comprises rank information corresponding to a number of layers used for data transmission and reception and modulation order information for the transmitted and received data, and a number of data streams based on a combination of the rank information and the modulation order information is greater than or equal to a threshold value, and
wherein the determining of the precoding matrix further comprises determining the precoding matrix based on at least one constellation point whose distance from a symbol corresponding to the data is less than a minimum Euclidean distance.

19. A modem chip in a wireless communication device configured to perform multiple-input and multiple-output (MIMO)-based communication with an external device, the modem chip comprising:
a radio frequency integrated circuit (RFIC) configured to receive a received signal including channel state information; and
at least one processor configured to determine a precoding matrix used to transmit data to the external device based on the channel state information,
wherein the at least one processor is further configured to:
generate a channel matrix corresponding to a channel based on the channel state information,
generate a diagonal matrix including singular values and right singular vectors, by performing singular value decomposition on the channel matrix,
generate an input matrix including valid components of the diagonal matrix including the singular values and having a preset first size,
generate an output matrix corresponding to the input matrix based on a universal neural network model, an input size of the universal neural network model being equal to the preset first size, and
determine the precoding matrix based on the output matrix and the right singular vectors.

20. The modem chip of claim 19, wherein a maximum number of layers available for data transmission and reception between the external device and the wireless communication device is Nₛ^{max}, where Nₛ^{max} is an integer of 1 or more, and
wherein the output matrix has a second size, and
wherein the preset first size is greater than 1×Nₛ^{max}, and the second size is 1×2(Nₛ^{max})².
